(19) United States
(12) Patent Application Publication
(10) Pub. No.: US 2003/0102830 A1
(43) Pub. Date: Jun. 5, 2003

(54) Driving circuit for brushless DC motor

(76) Inventors: Eiji Kubozuka, Kiryu-shi (JP); Koji Mizukami, Kiryu-shi (JP)

Correspondence Address: BIRCH STEWART KOLASCH & BIRCH, PO BOX 747, FALLS CHURCH, VA, 22040-0747, US

(21) Appl. No.: 10/286,858

(22) Filed: Nov. 4, 2002

(30) Foreign Application Priority Data
Nov. 5, 2001 (JP) 2001-339157

(51) Int. Cl. H02P 1/18; H02P 3/08

(52) U.S. Cl. 318/254

(57) ABSTRACT

The driving circuit comprises a current control signal generator means and a current switching circuit. The current control signal generator means comprises a current mode switching circuit and a current mode switching time setting means that counts reference clock pulses and outputs a counter signal until the number of pulses counted reaches a predetermined value. The current mode switching circuit chooses a three-phase current mode or a two-phase current mode according to the counter signal being transmitted or not and transmits the current mode chosen to the current switching circuit as current control signals.

### BACKGROUND OF THE INVENTION

1. Field of the Invention

The present invention concerns a driving circuit for a brushless DC motor. More particularly, the present invention concerns a driving circuit for a brushless DC motor capable of reducing a noise generated at the time when exciting currents supplied to stator windings are switched.

2. Description of the Prior Art

In a driving circuit for a three-phase brushless DC motor in the prior art, two stator windings are chosen from three stator windings according to output signals from three Hall devices for detecting magnetic pole position of a rotor comprising a permanent magnet, and exciting currents are supplied to the two stator windings chosen to make a two-phase excitation. Stator windings to be chosen are successively shifted in the rotational direction of the rotor to rotate the rotor.

In the three-phase brushless DC motor as explained above, there is a problem that a large noise is generated each time when the exciting currents supplied to the stator windings are switched, since the stator windings to which the exciting currents are supplied are successively shifted and the resultant magnetic field caused by the excited stator windings moves 120° in electric angle each time when the exciting currents are switched.

### SUMMARY OF THE INVENTION

It is an object of the present invention to solve the above problem and to provide a driving circuit for a brushless DC motor capable of reducing the noise by reducing the angular movement of the resultant magnetic field when the exciting currents are switched.

To achieve the above object, the driving circuit for a brushless DC motor according to the present invention comprises;

a current control signal generator means that receives output signals of three magnetic pole position detection means for detecting a magnetic pole position of a permanent magnet of a rotor of the motor and generates current control signals, and

a current switching circuit that receives the current control signals and supplies exciting currents to three-phase stator windings of the motor;

wherein the current control signal generator means comprises a combination circuit, a two-phase current mode generator, a three-phase current mode generator and a current mode switching time setting means,

the combination circuit combines the output signals of the magnetic pole position detection means and generates composite signal waves,

the two-phase current mode generator receives the composite signal waves and generates a two-phase current mode to be transmitted to the current switching circuit when exciting currents are to be supplied to two windings of the three stator windings,

the three-phase current mode generator receives the composite signal waves and generates a three-phase current mode to be transmitted to the current switching circuit when exciting currents are to be supplied to all three windings,

the current mode switching time setting means receives the composite signal waves, detects an edge of the composite signal wave, generates an edge signal, counts reference clock pulses starting from the edge signal, continues to output a counter signal until the number of pulses counted reaches a predetermined value, and stops outputting the counter signal at the time when the number of pulses counted reaches the predetermined value and is reset, and

the current mode switching circuit receives the two-phase current mode, the three-phase current mode and the counter signal, chooses the three-phase current mode while receiving the counter signal from the current mode switching time setting means and transmits the three-phase current mode to the current switching circuit as the current control signals, and chooses the two-phase current mode when the counter signal is not received from the current mode switching time setting means and transmits the two-phase current mode to the current switching circuit as the current control signals.

In the driving circuit for a brushless DC motor according to the present invention, the resultant magnetic field moves 60° each time when the excitation is switched from the three-phase excitation to the two-phase excitation, or from the two-phase excitation to the three-phase excitation. In the prior art in which only the two-phase excitation is made, the resultant magnetic field moves 120° each time when the exciting currents are switched. Thus, the change in the direction of the resultant magnetic field at each time when the exciting currents are switched in the brushless DC motor controlled by the driving circuit according to the present invention is half of that in the prior art. Accordingly, the noise generated with the movement of the resultant magnetic field can be reduced.

### BRIEF DESCRIPTION OF THE DRAWINGS

FIG. 1 is a block diagram of a driving circuit for a brushless DC motor according to the present invention.

FIG. 2 is a figure illustrating directions of stator windings to which exciting currents are supplied and the direction of the resultant magnetic field.

### DETAILED DESCRIPTION OF THE INVENTION

Now, preferred embodiments of the present invention are explained referring to the attached drawings.

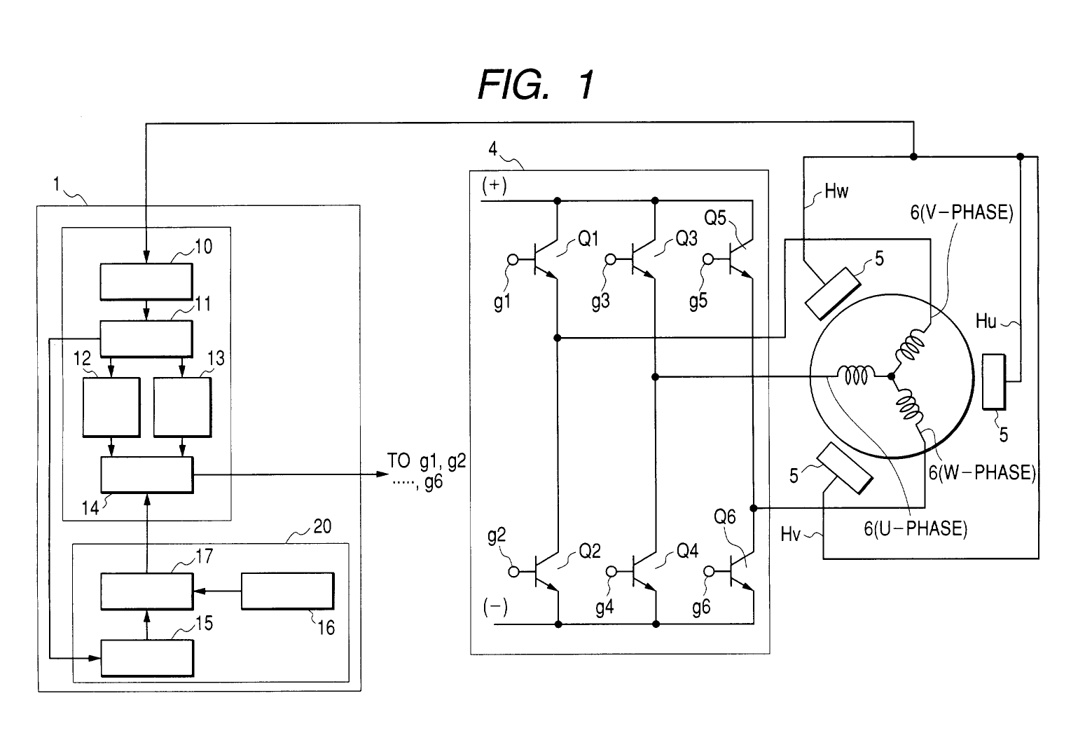

FIG. 1 is a block diagram of a driving circuit for a brushless DC motor according to the present invention.

The driving circuit shown in FIG. 1 comprises a current control signal generator means 1 and a current switching circuit 4.

The current control signal generator means 1 receives output signals Hu, Hv, Hw from three Hall devices 5 that are magnetic pole position detection means for detecting magnetic pole position of a permanent magnet of a rotor of a motor (not shown in the drawing) and generates current control signals.

The current switching circuit 4 receives the current control signals from the current control signal generator means 1 and supplies exciting currents to stator windings 6 of the motor.

The current control signal generator means 1 comprises a Hall device output amplifier 10, a combination circuit 11, a two-phase current mode generator 12, a three-phase current mode generator 13, a current mode switching circuit 14 and a current mode switching time setting means 20.

The Hall device output amplifier 10 receives the output signals Hu, Hv, Hw from the Hall devices 5 and amplifies the output signals Hu, Hv, Hw to make their amplitudes even.

The combination circuit 11 chooses appropriate signal waves from three signal waves of which amplitudes are made even by the Hall device output amplifier 10 and combines them to generate composite signal waves.

The two-phase current mode generator 12 receives the composite signal waves from the combination circuit 11 and generates a two-phase current mode to be transmitted to the current switching circuit when exciting currents are to be supplied to two stator windings 6 of the motor.

The three-phase current mode generator 13 receives the composite signal waves from the combination circuit 11 and generates a three-phase current mode to be transmitted to the current switching circuit when exciting currents are to be supplied to all three stator windings 6 of the motor.

The current mode switching time setting means 20 receives the composite signal waves from the combination circuit 11, detects an edge of the composite signal wave and generates an edge signal. Then, the current mode switching time setting means 20 counts reference clock pulses starting from the edge signal and continues to output a counter signal until the counted number of pulses reaches a predetermined value. At the time when the counted number of pulses reaches the predetermined value, the current mode switching time setting means 20 stops outputting the counter signal and is reset.

The current mode switching time setting means 20 that works as stated above can comprise an edge detection circuit 15, a reference clock signal generator 16 and a counter 17.

The edge detection circuit 15 receives the composite signal waves from the combination circuit 11, detects an edge of the composite signal wave and generates the edge signal.

The reference clock signal generator 16 generates reference clock pulses.

The counter 17 is started by the edge signal transmitted from the edge detection circuit 15, counts the number of the reference clock pulses, continues to output the counter signal until the number of pulses reaches the predetermined value, and stops outputting the counter signal and is reset when the number of pulses reaches the predetermined value.

The current mode switching circuit 14 receives the two-phase current mode and the three-phase current mode from the two-phase current mode generator 12 and the three-phase current mode generator 13 respectively. It also receives the counter signal from the counter 17.

While the counter signal is being transmitted from the current mode switching time setting means 20, the current mode switching circuit 14 chooses the three-phase current mode and transmits it to the current switching circuit 4 as the current control signals.

When the counter signal is not being transmitted from the current mode switching time setting means 20, the current mode switching circuit 14 chooses the two-phase current mode and transmits it to the current switching circuit 4 as the current control signals.

The current switching circuit 4 comprises transistors Q1 to Q6. Each of output terminals of the current mode switching circuit 14 is connected to corresponding one of gate terminals g1 to g6 of transistors Q1 to Q6. The current control signals are used to control “ON” or “OFF” of each of the transistors Q1 to Q6.

As shown in FIG. 1, the transistor Q1 and the transistor Q2 are connected in series between (+) and (−) of a power source. A point of connection of the transistor Q1 and the transistor Q2 is connected to one end of V-phase winding of the stator windings 6.

Similarly, the transistor Q3 and the transistor Q4 are connected in series between (+) and (−) of the power source. A point of connection of the transistor Q3 and the transistor Q4 is connected to one end of U-phase winding of the stator windings 6.

Also similarly, the transistor Q5 and the transistor Q6 are connected in series between (+) and (−) of the power source. A point of connection of the transistor Q5 and the transistor Q6 is connected to one end of W-phase winding of the stator windings 6.

Another end of the U-phase winding, another end of the V-phase winding and another end of the W-phase winding are connected together to form a center portion of the stator windings 6.

As stated above, the current control signals transmitted from the current mode switching circuit 14 are applied to respective gate terminals g1 to g6 of the transistors Q1 to Q6. TABLE 1 shows the relation among the currents in the transistors Q1 to Q6, the currents in the U, V, and W-phase windings 6, and an angle (hereinafter, angle refers to electric angle) of rotation of the permanent magnet of the rotor of the motor.

The TABLE 1 corresponds to a case in which the rotor rotates in CCW (counter clockwise). In the TABLE 1, “&Ovalhollow;” shows that the transistor is in “ON” state, “+” shows that the current is flowing from the one end of the winding to the center portion, “−” shows that the current is flowing from the center portion to the one end of the winding, and “X” shows that no current is flowing in the winding.

TABLE 1

| STEP NUMBER | | 1 | | 2 | | 3 | | 4 | | 5 | | 6 | |
|---|---|---|---|---|---|---|---|---|---|---|---|---|---|
| CURRENT | Q1 | 0 | 0 | 0 | | | | | | | | 0 | 0 |
| IN | Q2 | | | | | 0 | 0 | 0 | 0 | 0 | | | |
| TRANSISTOR | Q3 | | | | | | | 0 | 0 | 0 | 0 | 0 | |
| | Q4 | 0 | 0 | 0 | 0 | 0 | | | | | | | |
| | Q5 | | | 0 | 0 | 0 | 0 | 0 | | | | | |
| | Q6 | 0 | | | | | | | | 0 | 0 | 0 | 0 |
| CURRENT | U-phase | − | − | − | − | − | X | + | + | + | + | + | X |
| IN STATOR | V-phase | + | + | + | X | − | − | − | − | − | X | + | + |
| WINDING | W-phase | − | X | + | + | + | + | + | X | − | − | − | − |

| | | | | | | |
|---|---|---|---|---|---|---|
| ANGLE OF ROTATION | 0° | 60° | 120° | 180° | 240° | 300° |

In the TABLE 1, 360° angle of rotation of the permanent magnet of the rotor is divided into six steps, STEPs 1 to 6. Each step is further divided into a case in which the current is flowing in every winding of the U, V, and W-phase windings 6 and another case in which the current is flowing only in two windings of the U, V, and W-phase windings 6. Thus, there are twelve (12) current modes in all.

Now, the relation among the currents in the transistors Q1 to Q6, the currents in the U, V, and W-phase windings 6, and the angle of rotation of the permanent magnet of the rotor is explained referring to the TABLE 1.

At the start of the STEP 1, the edge detection circuit 15 detects an edge of the composite signal wave, generates the edge signal and transmits it to the counter 17. Then, the counter 17 transmits the counter signal to the current mode switching circuit 14. Then, the current mode switching circuit 14 chooses the three-phase current mode and transmits it to the current switching circuit 4 as the current control signals. In that case, a gate voltage is applied on the gate terminal g1 of the transistor Q1, on the gate terminal g4 of the transistor Q4, and on the gate terminal g6 of the transistor Q6. Then, the transistors Q1, Q4 and Q6 become “ON” state. The other transistors remain in “OFF” state. Accordingly, the current flows from the one end of the V-phase winding 6 to the center portion, from the center portion to the one end of the U-phase winding 6, and also from the center portion to the one end of the W-phase winding. Thus, a three-phase excitation in which U, V and W-phase windings are excited is realized.

After that, when the number of the reference clock pulses counted by the counter 17 reaches the predetermined value, the counter 17 stops transmitting the counter signal and is reset. Then, the current mode switching circuit 14 chooses the two-phase current mode and transmits it to the current switching circuit 4 as the current control signals. In this case, the gate voltage becomes to be not applied on the gate terminal g6 of the transistor Q6 and the transistor Q6 becomes “OFF” state. Then, the current to the W-phase winding is stopped and a two-phase excitation in which only U and V-phase windings are excited is realized.

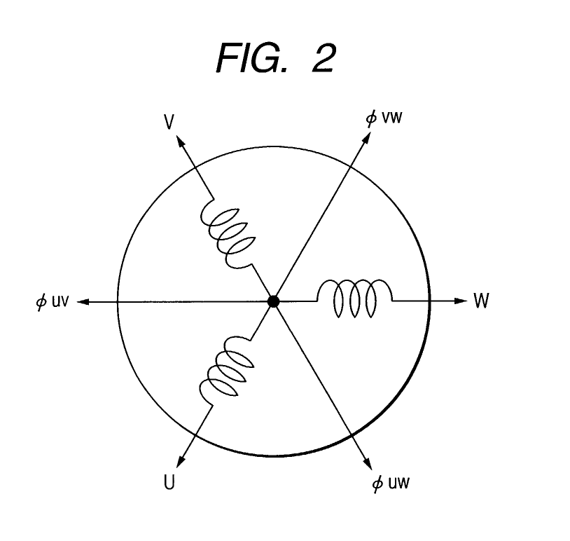

FIG. 2 illustrates directions of stator windings to which currents are supplied and the direction of the resultant magnetic field.

In the former stage of the STEP 1 in which the windings are in the three-phase excitation state, a direction of a resultant magnetic field caused by a magnetic field generated by the current flowing through the V-phase winding and another magnetic field generated by the current flowing through the U-phase winding is in a direction φuv lying midway between a direction of the V-phase winding V and a direction of the U-phase winding U. Also, a direction of a resultant magnetic field caused by a magnetic field generated by the current flowing through the V-phase winding and another magnetic field generated by the current flowing through the W-phase winding is in a direction φvw lying midway between the direction of the V-phase winding V and a direction of the W-phase winding W. Further, a direction of a resultant magnetic field caused by the above two resultant magnetic fields is in the direction of the V-phase winding V lying midway between the direction φuv and the direction φvw.

Next, in the latter stage of the STEP 1 in which the windings are in the two-phase excitation state, the current flows only through the V-phase winding and the U-phase winding. Accordingly, a direction of a resultant magnetic field caused by a magnetic field generated by the current flowing through the V-phase winding and another magnetic field generated by the current flowing through the U-phase winding is in the direction φuv lying midway between the direction of the V-phase winding V and the direction of the U-phase winding U.

Thus, an angle between the direction of the resultant magnetic field in the former stage of the STEP 1 and that in the latter stage of the STEP 1 is 60°, that is, a half of 120° that is the change in angle of the direction of the resultant magnetic field at each time when the currents are switched in the prior art in which only the two-phase excitation is made.

Next, when the rotor is rotated 60° , the step proceeds to the STEP 2. Again, the edge detection circuit 15 detects an edge of the composite signal wave, generates the edge signal and transmits it to the counter 17. Then, the counter 17 transmits the counter signal to the current mode switching circuit 14. Then, the current mode switching circuit 14 chooses the three-phase current mode and transmits it to the current switching circuit 4 as the current control signals. In that case, the gate voltage is applied on the gate terminal g1 of the transistor Q1, on the gate terminal g4 of the transistor Q4, and on the gate terminal g5 of the transistor Q5. Then, the transistors Q1, Q4 and Q5 become “ON” state. The other transistors are made to be “OFF” state. Accordingly, the current flows from the one end of the V-phase winding 6 to the center portion, from the center portion to the one end of the U-phase winding 6, and also from the one end of the W-phase winding to the center portion. Thus, a three-phase excitation in which U, V and W-phase windings are excited is realized.

In this case, a direction of a resultant magnetic field caused by a magnetic field generated by the current flowing through the V-phase winding and another magnetic field generated by the current flowing through the U-phase winding is in the direction φuv lying midway between the direction of the V-phase winding V and the direction of the U-phase winding U. Also, a direction of a resultant magnetic field caused by a magnetic field generated by the current flowing through the W-phase winding and another magnetic field generated by the current flowing through the U-phase winding is in a direction φuw lying midway between the direction of the W-phase winding W and the direction of the U-phase winding U. Further, a direction of a resultant magnetic field caused by the above two resultant magnetic fields is in the direction of the U-phase winding U lying midway between the direction φuv and the direction φuw.

Thus, an angle between the direction of the resultant magnetic field in the latter stage of the STEP 1 and that in the former stage of the STEP 2 is 60°, that is, a half of 120°.

After that, when the number of the reference clock pulses counted by the counter 17 reaches the predetermined value, the counter 17 stops transmitting the counter signal and is reset. Then, the current mode switching circuit 14 chooses the two-phase current mode and transmits it to the current switching circuit 4 as the current control signals. In this case, the gate voltage becomes to be not applied on the gate terminal g1 of the transistor Q1 and the transistor Q1 becomes “OFF” state. Then, the current to the V-phase winding is stopped and a two-phase excitation in which only W and U-phase windings are excited is realized.

In this case, the current flows only through the W-phase winding and the U-phase winding. Accordingly, a direction of a resultant magnetic field caused by a magnetic field generated by the current flowing through the W-phase winding and another magnetic field generated by the current flowing through the U-phase winding is in the direction φuw lying midway between the direction of the W-phase winding W and the direction of the U-phase winding U.

Thus, an angle between the direction of the resultant magnetic field in the former stage of the STEP 2 and that in the latter stage of the STEP 2 is again 60°, that is, a half of 120°.

Next, when the rotor is further rotated 60°, the step proceeds to the STEP 3. Again, the edge detection circuit 15 detects an edge of the composite signal wave, generates the edge signal and transmits it to the counter 17. Then, the counter 17 transmits the counter signal to the current mode switching circuit 14. Then, the current mode switching circuit 14 chooses the three-phase current mode and transmits it to the current switching circuit 4 as the current control signals. In that case, the gate voltage is applied on the gate terminal g2 of the transistor Q2, on the gate terminal g4 of the transistor Q4, and on the gate terminal g5 of the transistor Q5. Then, the transistors Q2, Q4 and Q5 become “ON” state. The other transistors are made to be “OFF” state. Accordingly, the current flows from the one end of the W-phase winding to the center portion, from the center portion to the one end of the U-phase winding, and from the center portion to the one end of the V-phase winding. Thus, a three-phase excitation in which U, V and W-phase windings are excited is realized.

In this case, a direction of a resultant magnetic field caused by a magnetic field generated by the current flowing through the W-phase winding and another magnetic field generated by the current flowing through the U-phase winding is in the direction φuw lying midway between the direction of the W-phase winding W and the direction of the U-phase winding U. Also, a direction of a resultant magnetic field caused by a magnetic field generated by the current flowing through the W-phase winding and another magnetic field generated by the current flowing through the V-phase winding is in the direction φvw lying midway between the direction of the W-phase winding W and the direction of the V-phase winding V. Further, a direction of a resultant magnetic field caused by the above two resultant magnetic fields is in the direction of the W-phase winding W lying midway between the direction φuw and the direction φvw.

Thus, an angle between the direction of the resultant magnetic field in the latter stage of the STEP 2 and that in the former stage of the STEP 3 is 60°, that is, a half of 120°.

After that, when the number of the reference clock signal counted by the counter 17 reaches the predetermined value, the counter 17 stops transmitting the counter signal and is reset. Then, the current mode switching circuit 14 chooses the two-phase current mode and transmits it to the current switching circuit 4 as the current control signals. In this case, the gate voltage becomes to be not applied on the gate terminal g4 of the transistor Q4 and the transistor Q4 becomes “OFF” state. Then, the current to the U-phase winding is stopped and a two-phase excitation in which only V and W-phase windings are excited is realized.

In this case, the current flows only through the V-phase winding and the W-phase winding. Accordingly, a direction of a resultant magnetic field caused by a magnetic field generated by the current flowing through the V-phase winding and another magnetic field generated by the current flowing through the W-phase winding is in the direction vw lying midway between the direction of the V-phase winding V and the direction of the W-phase winding W.

Thus, an angle between the direction of the resultant magnetic field in the former stage of the STEP 3 and that in the latter stage of the STEP 3 is again 60°, that is, a half of 120°.

Subsequently, similar switches from the three-phase excitation to the two-phase excitation, and from the two-phase excitation to the three-phase excitation, are repeated in the STEPs 4, 5, . . . , a direction of a resultant magnetic field moves 60° each time of the switching, and the rotor of the motor continues to be rotated.

Additionally, the above explanation is made for a case in which the current mode switching time setting means 20 comprises the edge detection circuit 15, the reference clock signal generator 16 and the counter 17. The current mode switching time setting means 20 can also be composed of a digital control circuit.

Further, the current mode switching time setting means 20 can also be composed of a microcomputer or a logical circuit.

In the driving circuit for a brushless DC motor according to the present invention, the resultant magnetic field moves 60° each time when the excitation is switched from the three-phase excitation to the two-phase excitation, or from the two-phase excitation to the three-phase excitation. In the prior art in which only the two-phase excitation is made, the resultant magnetic field moves 120 each time when the exciting currents are switched. Thus, the change in the direction of the resultant magnetic field at each time when the exciting currents are switched in the brushless DC motor controlled by the driving circuit according to the present invention is half of that in the prior art. Accordingly, the noise generated with the movement of the resultant magnetic field can be reduced.

What is claimed is:

1. A driving circuit for a brushless DC motor comprising;
a current control signal generator means that receives output signals of three magnetic pole position detection means for detecting a magnetic pole position of a permanent magnet of a rotor of the motor and generates current control signals, and
a current switching circuit that receives said current control signals and supplies exciting currents to three-phase stator windings of said motor;
wherein said current control signal generator means comprises a combination circuit, a two-phase current mode generator, a three-phase current mode generator and a current mode switching time setting means,
said combination circuit combines said output signals of said magnetic pole position detection means and generates composite signal waves,
said two-phase current mode generator receives said composite signal waves and generates a two-phase current mode to be transmitted to the current switching circuit when exciting currents are to be supplied to two windings of said three stator windings,
said three-phase current mode generator receives said composite signal waves and generates a three-phase current mode to be transmitted to the current switching circuit when exciting currents are to be supplied to all three windings of said stator windings,
said current mode switching time setting means receives said composite signal waves, detects an edge of said composite signal wave, generates an edge signal, counts reference clock pulses starting from said edge signal, continues to output a counter signal until the number of pulses counted reaches a predetermined value, and stops outputting said counter signal at the time when said number of pulses counted reaches said predetermined value and is reset, and
said current mode switching circuit receives said two-phase current mode, said three-phase current mode and said counter signal, chooses said three-phase current mode while receiving said counter signal from said current mode switching time setting means and transmits said three-phase current mode to said current switching circuit as said current control signals, and chooses said two-phase current mode when said counter signal is not received from said current mode switching time setting means and transmits said two-phase current mode to said current switching circuit as said current control signals.

2. The driving circuit for a brushless DC motor according to claim 1 wherein said current mode switching time setting means comprises;
an edge detection circuit that receives said composite signal waves from said combination circuit, detects said edge of said composite signal wave and generates said edge signal,
a reference clock signal generator that generates said reference clock pulses, and
a counter that is started by said edge signal, counts a number of said reference clock pulses, outputs said counter signal until said number of pulses reaches said predetermined value, and stops outputting said counter signal and is reset when said number of pulses reaches said predetermined value.

3. The driving circuit for a brushless DC motor according to claim 1 wherein said current mode switching time setting means comprises a digital control circuit.

4. The driving circuit for a brushless DC motor according to claim 1 wherein said current mode switching time setting means comprises a microcomputer.

5. The driving circuit for a brushless DC motor according to claim 1 wherein said current mode switching time setting means comprises a logical circuit.
